(19) United States
(12) Patent Application Publication
(10) Pub. No.: US 2013/0196229 A1
(43) Pub. Date: Aug. 1, 2013

(54) ENERGY STORAGE ELEMENT, METAL COMPONENT, AND ENERGY STORAGE ELEMENT MANUFACTURING METHOD

(71) Applicant: GS Yuasa International Ltd., Kyoto-shi (JP)

(72) Inventors: Yu Shiraishi, Kyoto (JP); Syun Ito, Kyoto (JP); Seiichi Irie, Kyoto (JP)

(73) Assignee: GS Yuasa International Ltd., Kyoto-shi (JP)

(21) Appl. No.: 13/748,106

(22) Filed: Jan. 23, 2013

(30) Foreign Application Priority Data
Jan. 27, 2012 (JP) 2012-015809
Dec. 21, 2012 (JP) 2012-280115

(51) Int. Cl. H01M 2/30; H01G 9/008

(52) U.S. Cl. CPC H01M 2/30; H01G 9/008
USPC 429/211; 361/500; 29/874

(57) ABSTRACT

An energy storage element includes: a metal component that is a metal plate member that includes a protrusion extending from a surface of the metal plate member, and is provided as a portion of a container. The protrusion includes: a tubular portion provided at a tip end of the protrusion in an extending direction, and a base portion that is solid and extends from the surface of the metal component to the tubular portion in the extending direction.

### CROSS REFERENCE TO RELATED APPLICATIONS

The present application is based on and claims priority of Japanese Patent Application No. 2012-015809 filed on Jan. 27, 2012 and Japanese Patent Application No. 2012-280115 filed on Dec. 21, 2012. The entire disclosure of the above-identified application, including the specification, drawings and claims is incorporated herein by reference in its entirety.

### FIELD

The present invention relates to an energy storage element having a metal component that is a metal plate member provided as a portion of a container and includes a protrusion extending from a surface thereof, the metal component itself, and a manufacturing method of an energy storage element.

### BACKGROUND

Metal components provided with protrusions are used for a variety of purposes. For example, in Patent Literature (PTL) 1, a metal component is positioned and fixed with another component using a protrusion.

Formation of the protrusion on the metal plate member can include forming a solid protrusion, such as is the case in PTL 1.

### CITATION LIST

### Patent Literature

PTL 1

Japanese Unexamined Patent Application Publication No. 2001-340928

### SUMMARY

The aim of the present invention is to provide a metal component formed by forming a protrusion on a plate shaped member while ensuring the mechanical strength of and in the vicinity of the protrusion.

In order to achieve the above described goal, the present disclosure provides an energy storage element including a metal component that is a metal plate member, includes a protrusion extending from a surface of the metal component, and is provided as a portion of a container, wherein the protrusion includes: a tubular portion provided at a tip end of the protrusion in an extending direction that intersects with the surface; and a base portion that is solid or tubular and extends from the surface of the metal component to the tubular portion in the extending direction, the base portion, when tubular, having a wall thickness greater than a wall thickness of the tubular portion.

In other words, when the energy storage element is provided with, as a portion of the container, a metal component formed by forming a protrusion on a plate member, and the protrusion is engaged with another component, the base end of the protrusion often bears external force exerted along the surface formed by the protrusion.

For this reason, the base end of the protrusion is formed as a base portion that is solid or tubular with thick walls to ensure the strength of the base end of the protrusion.

On the other hand, the tip end of the protrusion in the extending direction, which does not necessarily need to bear the exertion of external forces, is formed as a tubular portion having a hallow center to simplify the forming process and subsequent transformations to be performed.

Moreover, the base portion and the tubular portion may be seamless and share a central axis.

In other words, the tubular portion is provided to ensure that the protrusion is of sufficient height and that other processes, such as processing performed upon assembly of the protrusion with other components, can be performed with ease. Moreover, the provision of the solid base portion ensures that the protrusion is of sufficient supporting strength.

Moreover, a wall of the protrusion may be formed to gradually decrease in thickness in the extending direction from a base end toward the tip end.

With this, the base end region of the protrusion is thicker than the wall of the tip end region of the tubular portion, thereby functioning as the base portion and ensuring that the protrusion is of sufficient strength.

Moreover, the energy storage element may include a depression that is closed-ended, formed on a surface on an opposite side of the metal component from a surface on which the protrusion is formed, and positioned to overlap a position of the protrusion when viewed from the extending direction.

In other words, shaping the surface of the metal component that is opposite to the surface on which the protrusion is formed to have a depression makes it possible to use the depression as the supply source for the material to become the protrusion when the protrusion is formed on the plate component using plastic working.

Furthermore, by forming the depression to be closed-ended, the front surface and the back surface of the metal component at the formation site of the protrusion are not penetrated through. On the contrary, a wall is formed blocking ventilation between the front surface and the back surface of the metal component. This is particularly useful when the metal component forms a portion of an airtight container where it is preferable that ventilation between the front surface and the back surface of the metal component is blocked.

Moreover, a distance between a bottom of the depression and the tip end of the protrusion in the extending direction may be shorter than a distance between the surface of the metal component on which the protrusion is formed and the tip end of the protrusion in the extending direction.

In other words, when the protrusion is formed by plastic working, the depression, which is formed to acquire material for the formation of the protrusion, is formed to be substantially deep to secure a sufficient amount of material for the protrusion.

Even with such a configuration, the wall thickness of the protrusion, formed by both the side surfaces of the depression and the side surfaces of the protrusion, can be made to be a thickness that provides sufficient strength by setting the width of the depression adequately.

Moreover, the depression may be formed to be wider than the protrusion when viewed from the extending direction.

In other words, formation of a protrusion of sufficient size can be ensured by forming the depression to be wide enough to secure a sufficient amount of source material for the protrusion.

Moreover, the depression may be less than half as deep as the metal component is thick.

With this, it is possible to ensure that the vicinity of the protrusion is high in mechanical strength by forming a wall of sufficient thickness in a portion of the metal component from the bottom of the depression to the bottom of the protrusion.

Moreover, the depression may be provided on a same surface of the metal component that the protrusion is formed on.

In other words, by providing the depression formed to secure source material for the formation of the protrusion on the surface of the plate component on which the protrusion is formed, the surface of the plate component opposite the surface on which the protrusion is formed can be kept from substantially deforming in the formation of the protrusion.

Moreover, the protrusion may engage with a gasket (packing member) provided between an electrode terminal and the metal component.

In other words, by having a configuration in which the electrode terminal and the gasket are assembled with the metal component as assembly parts and the gasket and the protrusion are assembled to engage, rotation of the electrode terminal can be prevented via the gasket.

Moreover, the tubular portion may be swaged.

In other words, when the assembly parts the electrode terminal and the gasket are assembled with the metal component, the assembly parts may be fixed by swaging the tubular portion of the protrusion fitting through the through holes.

Moreover, a through hole may be formed in the gasket, and the through hole may include an inclined surface that gradually inclines away from the surface of the metal component from the inside of the through hole engaging with the swaged tubular portion out. Here, a distance between the inclined surface and the surface of the metal component may be greater than a distance between the base portion and the surface of the metal component.

With this, when the tubular portion of the protrusion is swaged, the wall of the tubular portion transforms into a shape determined by the inclined surface, thereby restricting excessive deformation of the tubular portion wall from the swaging and preventing the wall of the tubular portion from becoming damaged. Furthermore, with the provision of the inclined surface, the length of the tubular portion can be shortened.

Moreover, the metal component is a portion of the container of the energy storage element, and the assembly part is a gasket that is provided between the electrode terminal and the metal component.

As a result, when the plate component forming a part of the energy storage element container and the gasket are assembled in the assembly of the energy storage element, the protrusion formed in the plate component is fitted into the through hole formed in the gasket.

Moreover, a plurality of protrusions may be provided on the metal component which engage with one gasket.

That is, a plurality of protrusions may be used to position and fix a single gasket.

Moreover, a method of manufacturing an energy storage element including, as a portion of a container, a metal component that is a metal plate member and includes a protrusion extending from a surface of the metal component, may include forming, by pressing the metal plate member, the protrusion including (i) a tubular portion provided at a tip end of the protrusion in an extending direction that intersects with the surface and (ii) a base portion that is solid or tubular and extends from the surface of the metal component to the tubular portion in the extending direction, the base portion, when tubular, having a wall thickness greater than a wall thickness of the tubular portion.

Moreover, the method may include swaging the tubular portion of the protrusion while the protrusion is fitted in a through hole formed in a gasket placed between an electrode terminal and the metal component.

In other words, the swaging of the protrusion can be easily performed due to the provision of the tubular portion on the tip end of the protrusion in the extending direction.

### BRIEF DESCRIPTION OF DRAWINGS

These and other objects, advantages and features of the disclosure will become apparent from the following description thereof taken in conjunction with the accompanying drawings that illustrate a specific embodiment of the present invention.

FIG. 1 is an external perspective view of the energy storage element according to an embodiment of the present invention.

FIG. 2 is a perspective view showing the internal structure of the energy storage element according to an embodiment of the present invention.

FIG. 3 is a cross-sectional view of a main component of the energy storage element according to an embodiment of the present invention.

FIG. 4 is a cross-sectional view of a main component showing an assembly process according to an embodiment of the present invention.

FIG. 5 is a cross-sectional view of a main component showing an assembly process according to an embodiment of the present invention.

FIG. 6 is a cross-sectional view of a main component showing an assembly process according to an embodiment of the present invention.

FIG. 7 is a perspective view of a main component according to an embodiment of the present invention.

FIG. 8 is an exploded view of a main component according to an embodiment of the present invention.

FIG. 9A is a cross-sectional view of a main component of an energy storage element according to a different embodiment of the present invention.

FIG. 9B is a cross-sectional view of a main component of an energy storage element according to a different embodiment of the present invention.

FIG. 9C is a cross-sectional view of a main component of an energy storage element according to a different embodiment of the present invention.

FIG. 9D is a cross-sectional view of a main component of an energy storage element according to a different embodiment of the present invention.

FIG. 9E is a cross-sectional view of a main component of an energy storage element according to a different embodiment of the present invention.

FIG. 10 is a cross-sectional view of a main component according to a different embodiment of the present invention.

### DESCRIPTION OF EMBODIMENTS

Although an entirely solid and mechanically strong protrusion that is highly resistive to external force can be produced, the process for forming such a protrusion is not simple. Moreover, the treatment required to further transform the protrusion for, for example, assembly with another part, is also not simple.

While it is conceivable to press the entire protrusion into a tubular structure as a means to simplify the forming process, this reduces the mechanical strength of the protrusion.

Moreover, when a protrusion that is solid is formed on the plate component by plastic deformation, reduction in the mechanical strength of the protrusion is also a concern since a portion of the plate component thickness is compromised by the formation.

The present invention has been conceived in light of the above knowledge and aims to provide an energy storage element provided with, as a portion of the container, a metal component which includes an easily formable and treatable protrusion and which can ensure that the protrusion and surrounding area is of sufficient strength.

Hereinafter, an embodiment of the present invention is described with reference to the Drawings.

This embodiment focuses on an energy storage element provided with, as a portion of a container, a metal component on which a protrusion is formed.

A non-aqueous electrolyte secondary battery (specifically, a lithium-ion battery), which is an example of a secondary battery, will be used to exemplify the energy storage element.

It is to be noted that “energy storage element” is used here as a broad term including capacitors and secondary batteries that are elements (devices) capable of charging and discharging.

### (Configuration of the Energy Storage Element 100 (Non-Aqueous Electrolyte Secondary Battery))

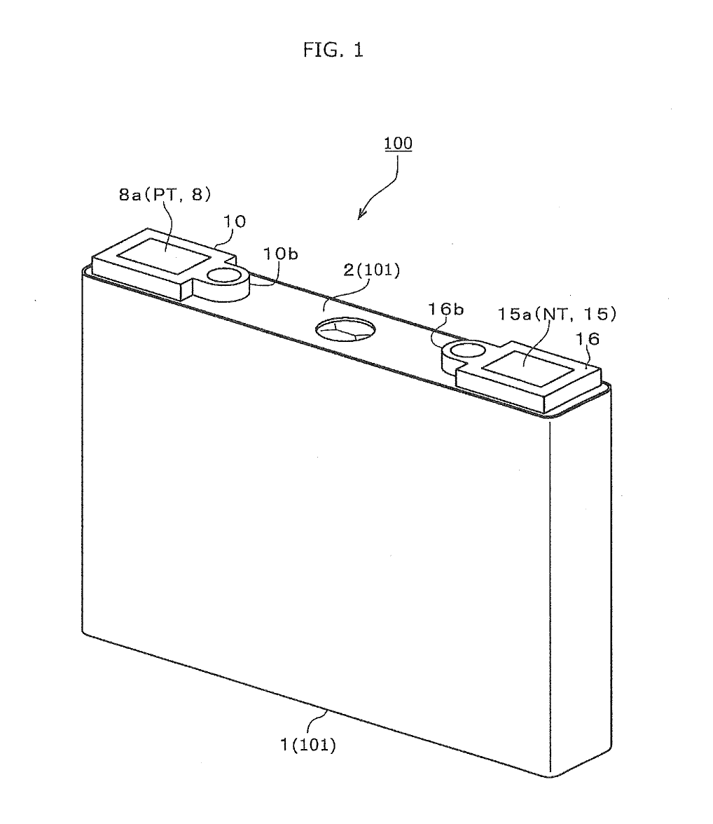

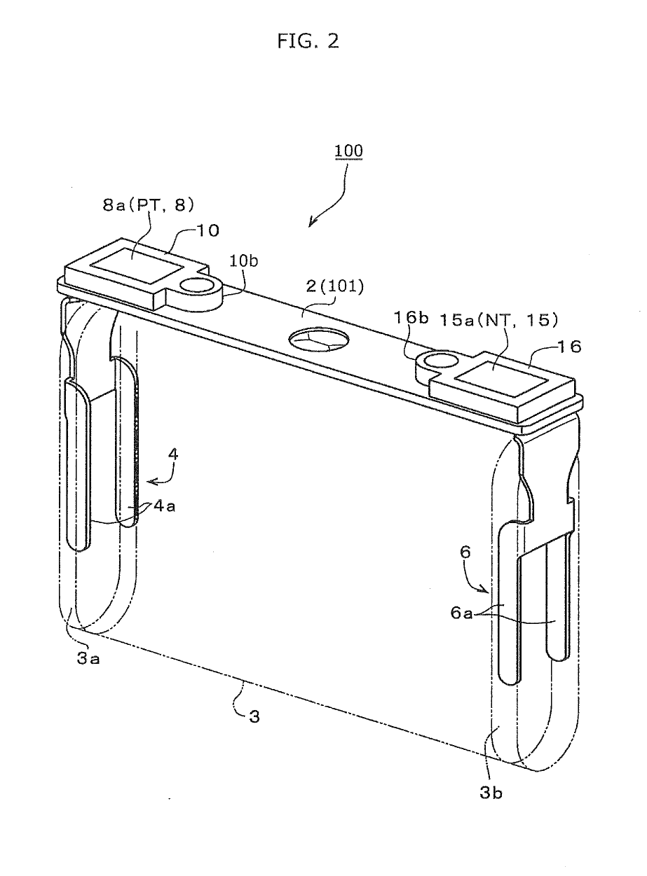

As FIG. 1 and FIG. 2 show, the energy storage element 100 according to this embodiment includes a container 101 configured of a case 1 which is a closed-ended tube (more specifically a closed-ended rectangular tube) and a cover plate 2 which is a metal component that covers an open end of the case 1. In this embodiment, the cover plate 2 is welded to the case 1 to seal the case 1.

The cover plate 2 metal component is formed from a rectangular (long and narrow) plate component. A positive electrode terminal PT and a negative electrode terminal NT are provided on a surface of the cover plate 2 towards their respective ends of the container 101.

The shape of case 1 including the cover plate 2 is a thin cube with housing room therein. The overall shape of the case 1 is a closed-ended rectangular tube or a rectangular container-like shape. Therefore, the container 101 configured of the case 1 and the cover plate 2 is substantially thin and cuboid in shape. It is to be noted that FIG. 2 shows the internal configuration of the container 101 separated from the case 1 and the complete energy storage element 100 (shown in FIG. 1). An electrode assembly 3 (to be described later) is shown by a dotted and dashed line. The purpose of FIG. 2 is to allow for easy visualization of the internal structure.

As shown in FIG. 2, the electrode assembly 3 represented by the dotted and dashed line, a current collector 4, and a current collector 6 are stored inside the container 101 immersed in an electrolyte.

The current collector 4 and the current collector 6 are members for electrically connecting the electrode terminal PT and NT to the electrode assembly 3.

Both the current collector 4 and the current collector 6 are conductors having substantially the same shape, and are positioned symmetrically. Moreover, the material properties of the current collector 4 and the current collector 6 are different. Specifically, the positive current collector 4 contains mainly aluminum, and the negative current collector 6 contains mainly copper.

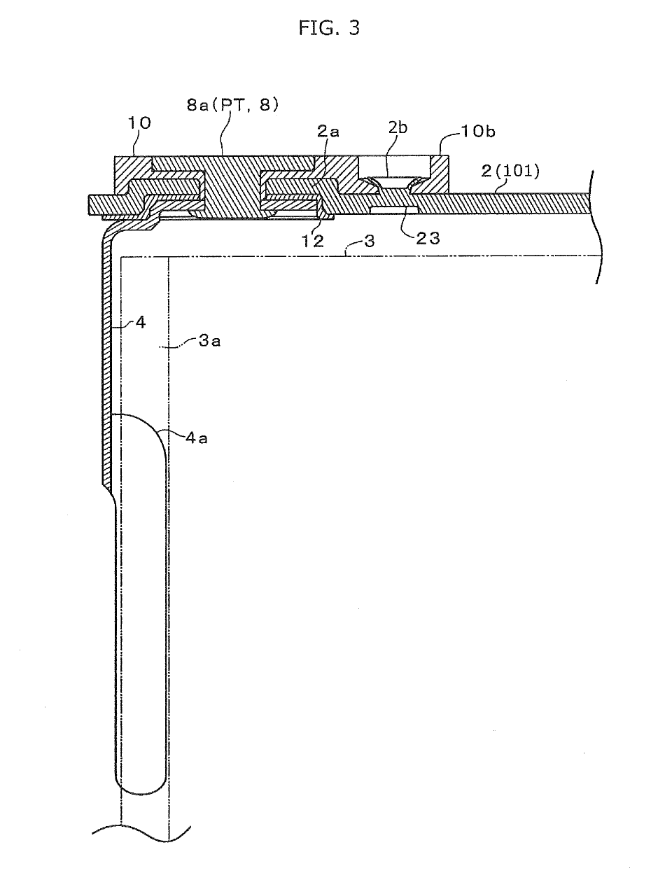

FIG. 3 is a cross-sectional front view showing the positive electrode terminal PT and surrounding components.

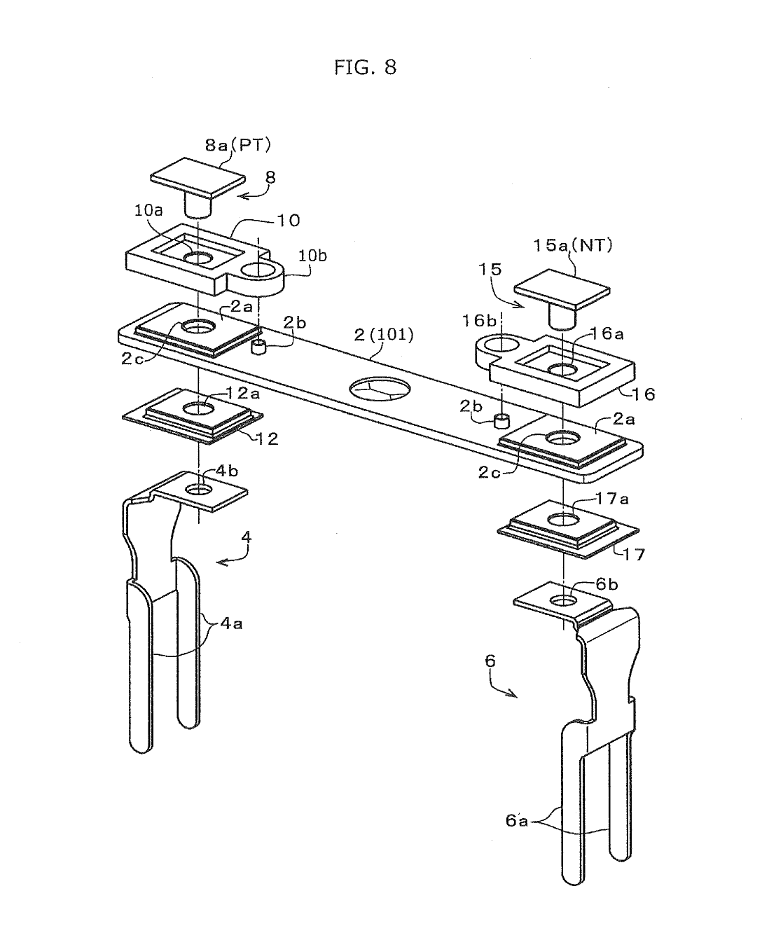

FIG. 8 is an exploded perspective view of assembly components including the cover plate.

The substantially L shaped current collector 4 and current collector 6 shown in FIG. 3 and FIG. 8 are formed by bending plate components of the above-described materials. Moreover, the vertically extending portions of the current collector 4 and the current collector 6 are bent toward the electrode assembly 3. The bending process forms a connecting portion 4a and a connecting portion 6a on the current collector 4 and current collector 6, respectively, for connecting with the electrode assembly 3. A rivet attachment hole 4b and a rivet attachment hole 6b for insertion of a rivet 8 and a rivet 15 are formed in the top ends of the current collector 4 and the current collector 6 (the portion extending horizontally), respectively.

The electrode assembly 3 includes, as a pair of electrode plates, a long foil-like positive electrode plate coated with an active material and a long foil-like negative electrode plate coated with an active material. The electrode assembly 3 also includes an insulative separator formed as a long sheet or long foil-like article. A layered structure in which the separator is placed between the positive electrode plate and the negative electrode plate to prevent conductivity therebetween is wound to form the electrode assembly 3.

An uncoated section 3a of the wound electrode assembly 3, which is an end of the foil-like positive electrode plate uncoated with an active material, extends out to one side (that is, in a direction perpendicular to the lengthwise direction of the foil-like positive electrode plate), and an uncoated section 3b of the wound electrode assembly 3, which is an end of the foil-like negative electrode plate uncoated with an active material, extends out to another side opposite the side to which the uncoated section 3a extends (that is, in a direction perpendicular to the lengthwise direction of the foil-like negative electrode plate).

In this embodiment, the electrode assembly 3 is formed by winding the positive electrode plate, the negative electrode plate, and the separator to be accommodated in the container 101.

The electrode assembly 3 sits in the case 1 such that the electrode assembly 3 winding axis is parallel to the lengthwise direction of the cover plate 2. As the schematics in FIG. 2 show, when viewed from the front, the uncoated section 3a of the positive electrode plate is positioned to overlap the connecting portion 4a of the current collector 4, and the uncoated section 3b of the negative electrode plate is positioned to overlap the connecting portion 6a of the current collector 6.

The uncoated section 3a of the positive electrode plate is welded to the connecting portion 4a of the current collector 4 while overlapping it. Moreover, the uncoated section 3b of the negative electrode plate is welded to the connecting portion 6a of the current collector 6 while overlapping it.

The positive electrode terminal PT mounted to the metal (specific examples include aluminum and stainless steel) cover plate 2 is electrically connected to the current collector 4, and the negative electrode terminal NT is electrically connected to the current collector 6.

The manner in which the positive electrode terminal PT is mounted to the cover plate 2 and connected to the current collector 4 is substantially the same as the manner in which the negative electrode terminal NT is mounted to the cover plate 2 and connected to the current collector 6. Moreover, these two structures are symmetrically positioned. The only difference is the material properties of the respective metal members.

Hereinafter the configuration of the positive electrode side will be explained.

As FIG. 3 shows, a rivet head 8a of the rivet 8 formed of a metallic conductive material (specifically, aluminum) functions as the positive electrode terminal PT. As FIG. 3 also shows, the end of the rivet 8 that is swaged inside the container 101 is electrically connected to the current collector 4.

The rivet head 8a of the rivet 8 is surrounded and held by a resin upper gasket 10 (upper packing member) which is a sealing member made of an electrically insulative material.

The upper gasket 10 insulates the cover plate 2 and the rivet 8 functioning as the electrode terminal PT. The top surface (outer surface) of the upper gasket 10 is formed to have a recess which corresponds with the shape of the rivet head 8a (which, in this embodiment, is substantially cuboid in shape) of the rivet 8. The bottom surface (inner surface) of the upper gasket 10 is formed to have a recess that corresponds with the external shape of a raised collector seat 2a formed on the top surface of the cover plate 2. A through hole 10a through which the rivet 8 is inserted is formed in the wall of the upper gasket 10 that separates the recess on the top surface and the recess on the bottom surface is (see FIG. 8). The wall of the through hole 10a extends cylindrically in the insertion direction of the rivet 8, and covers the perimeter of the rivet 8.

Furthermore, a positioning portion 10b is formed on the upper gasket 10 extending in a lengthwise direction of the cover plate 2 from the holding portion of the rivet 8. The positioning portion 10b engages with the protrusion 2b which extends outward from the cover plate 2 of the container 101.

A resin lower gasket 12 (lower packing member) which is a sealing member made of an electrically insulative material is positioned between the cover plate 2 and the current collector 4 on the inside of the container 101 on the electrode terminal PT side.

The top surface of the lower gasket 12 is formed to have a raised portion which corresponds with the recess formed in the bottom surface of the cover plate 2 upon formation of the raised collector seat 2a. The bottom surface of the lower gasket 12 is formed to have a recess into which the top of the current collector 4 fits. The lower gasket 12 is also provided with a through hole 12a through which the rivet 8, for example, is inserted.

The rivet 8 is inserted to pass through the through hole 10a in the upper gasket 10, the through hole 2c in the raised collector seat 2a of the cover plate 2, the through hole 12a in the lower gasket 12, and the rivet attachment hole 4b in the current collector 4. The rivet 8 is then swaged to sandwich these parts together. The current collector 4 and the rivet head 8a of the rivet 8 functioning as the electrode terminal PT are fixed to the cover plate 2 with the swaging of the rivet 8, and the rivet 8 and the current collector 4 are electrically insulated from the cover plate 2 by the upper gasket 10 and the lower gasket 12 sandwiched therebetween. Moreover, the clamping power of the swaged rivet 8 hermetically seals the components.

The configuration of the negative electrode terminal NT is similar to the positive electrode terminal, and includes the rivet 15 formed of a metallic conductive material, a resin upper gasket 16 (upper packing member) which is a sealing member made of an electrically insulative material, and a lower gasket 17 (lower packing member). On the negative side, the top surface of the upper gasket 16 holds the rivet head 15a of the rivet 15 functioning as the electrode terminal NT, the bottom surface of the upper gasket 16 holds the raised collector seat 2a, and the wall of a through hole 16a extends cylindrically and covers the perimeter of the rivet 8.

Moreover, the raised portion formed on the top surface the lower gasket 17 fits with the bottom surface of the raised collector seat 2a of the cover plate 2, and the recess formed on the bottom surface of the lower gasket 17 holds the end of the current collector 6.

The rivet 15 is passed through the through hole 16a in the upper gasket 16, the through hole 2c in the raised collector seat 2a of the cover plate 2, the through hole 17a in the lower gasket 17, and the rivet attachment hole 6b in the current collector 6, then swaged to sandwich these parts together. This electrically insulates the components from the cover plate 2 and hermetically seals the components.

Next, the process of assembling the assembly components to the cover plate 2 in the manufacturing process of the energy storage element 100 will be discussed.

As described above, the cover plate 2 assembly components are configured as follows: the rivet 8 (electrode terminal PT), the rivet 15 (electrode terminal NT), the current collector 4, and the current collector 6 are attached to the cover plate 2 using the upper gasket 10 and 16 and the lower gasket 12 and 17.

As is shown in FIG. 8, a raised collector seat 2a and a protrusion 2b are formed on the central component, the cover plate 2, at the positive and negative electrode sides. Two protrusions 2b when viewed from the extending direction (normal direction of the surface of the cover plate 2) are formed between the two raised collector seats 2a. Moreover, the two protrusions 2b are formed at the side of (in the vicinity of) the rivet head 8a of the rivet 8 and the rivet head 15a of the rivet 15 for positioning the rivet head 8a of the rivet 8 and the rivet head 15a of the rivet 15, which are the electrode terminal PT and the electrode terminal NT, respectively.

The raised collector seat 2a and the protrusion 2b are formed by plastic working (specifically, press working) a thin, flat, rectangular metal plate (the cover plate 2).

Schematically, the raised collector seat 2a is pressed toward the outside of the container 101 to rise into a substantially rectangular shape in the cover plate 2. This raised collector seat 2a formed rising out from the container 101 fits with the bottom recessed surface of the upper gasket 10 and the upper gasket 16 to position the upper gasket 10 and the upper gasket 16. Moreover, the recessed seat formed on the inside of the container 101 fits with and positions the lower gasket 12 and the lower gasket 17.

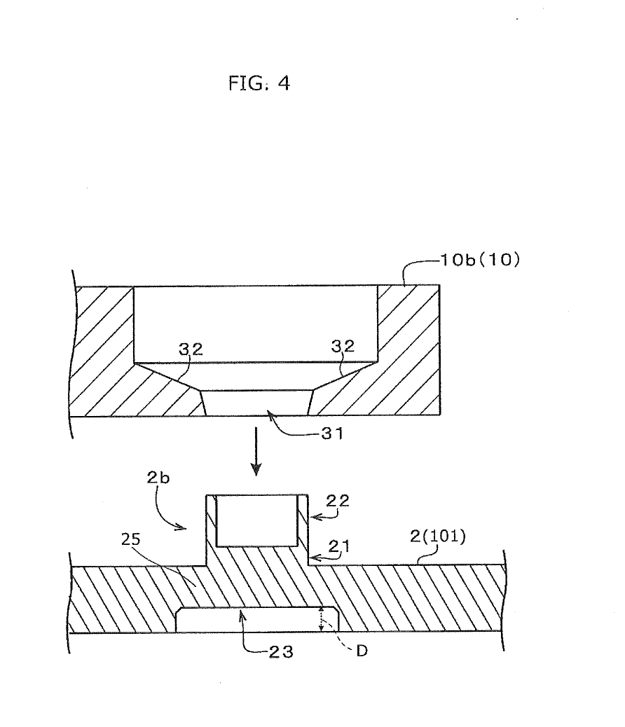

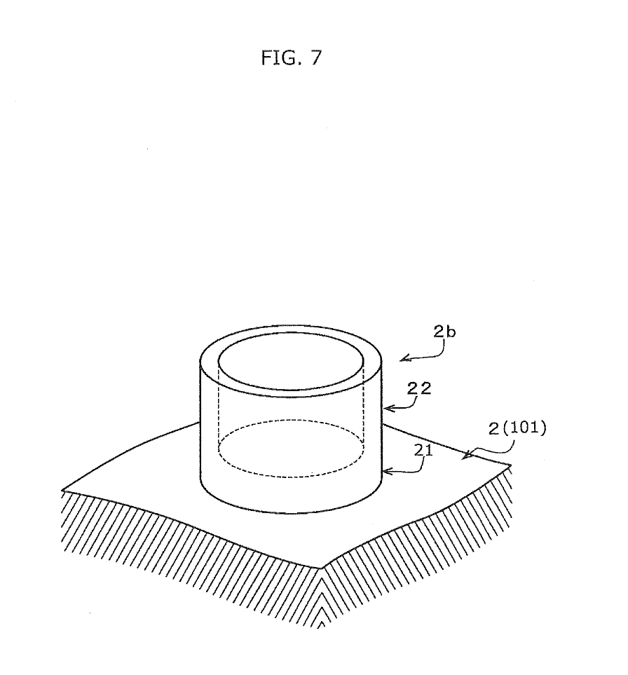

FIG. 4 and FIG. 7 are enlarged cross-sectional views of the location in which the protrusion 2b is formed.

As shown, the protrusion 2b has a form in which a base portion 21 and a tubular portion 22 are stacked on the top surface of the cover plate 2.

The base portion 21 forms the end of the protrusion 2b nearest the cover plate, and continuously extends from the surface of the cover plate 2 outward. In this embodiment, the base portion 21 is a solid cylinder extending in a direction perpendicular to the surface of the cover plate 2.

The tubular portion 22 is formed on the tip end of the protrusion 2b, and continuously extends from the base portion 21 outward. In this embodiment, the tubular portion 22 is a tube (specifically, a cylindrical tube) with an open end at the tip.

In this embodiment, the base portion 21 and the tubular portion 22 share a central axis which follows the normal direction of the cover plate 2 (the extending direction of the protrusion 2b).

The solid base portion 21 provides structural strength between the protrusion 2b and the cover plate 2. That is to say, in the case that the protrusion 2b were subjected to an external force via the upper gasket 10 and the upper gasket 16 which are engaged with the protrusion 2b, the base portion 21 provides the protrusion 2b with strong support against said external force.

Moreover, with the provision of the tubular portion 22, the overall bulk of the protrusion 2b can be kept to a minimum and the protrusion 2b can be formed by plastic working without sacrificing the thickness of the cover plate 2 too much. It is to be noted that the tubular portion 22 having a hallow center at the tip end of the protrusion 2b in the extending direction may be swaged in the assembly of the upper gasket 10 and the upper gasket 16.

On the other hand, formed on the inner surface of the cover plate 2 of the container 101 (that is, the surface of the cover plate 2 opposite the surface on which the protrusion 2b is formed) is a depression 23 (see FIG. 4, for example). The depression 23 when viewed from the extending direction of the protrusion 2b (that is, in planes parallel to the surface of the cover plate 2) is positioned to overlap the position of the protrusion 2b. In this embodiment, the depression 23 is a cylindrical depression which shares a central axis with the protrusion 2b. Moreover, the plate component on which the protrusion 2b is formed (the cover plate 2) is a portion of the container 101 of the energy storage element 100. In order for the container 101 to have a hermetically sealed structure, the area in which the protrusion 2b is formed must not allow ventilation between the outside and inside of the container 101. For this reason, the depression 23 is formed to be closed-ended. The portion from the bottom surface of the depression 23 to the base portion 21 is a wall 25 which secures that the container 101 is airtight.

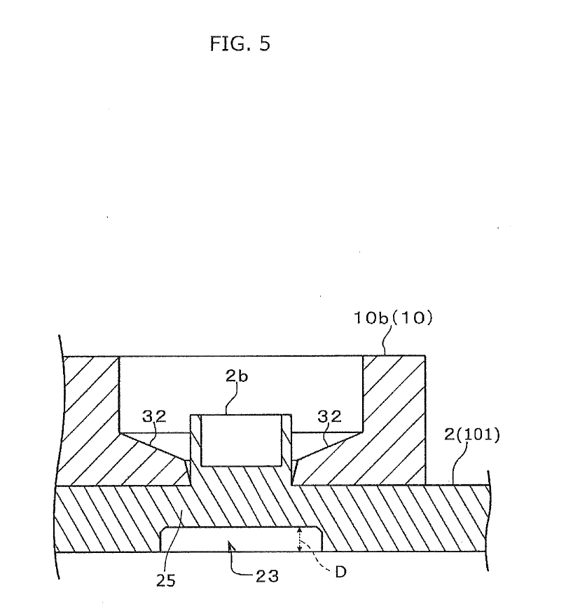

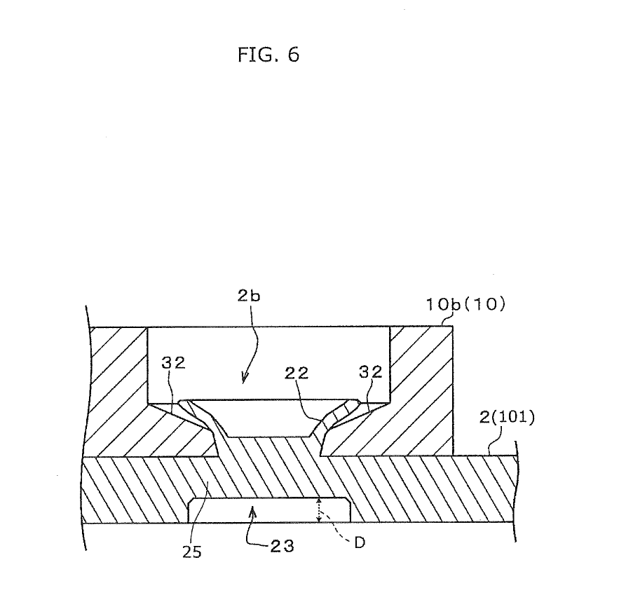

It is to be noted that when the protrusion 2b is formed on a portion of the cover plate 2, providing a depression 23 that is wider than the protrusion 2b, and in particular providing a depression 23 having a bottom that is wider than the protrusion 2b, as FIG. 4, FIG. 5, and FIG. 6 show, is preferable for preventing fissures in the protrusion 2b formation area since doing so is easier to ensure that the thickness of the wall 25 will be thicker than half the thickness of the cover plate 2 in the plastic working process for forming the protrusion 2b.

In other words, it is possible to ensure high mechanical strength in the vicinity of the protrusion 2b by, as FIG. 4, FIG. 5, and FIG. 6 show, designing the depression 23 to have a depth D that is less than half of the thickness of the cover plate 2 and to have increased surface area in a direction perpendicular to the central axis thereof and forming the protrusion 2b by plastic working.

Therefore, even if the pressure inside the container 101 increases, the vicinity of the protrusion 2b can sufficiently withstand said pressure.

By forming the depression 23 to be shallow, the protrusion 2b and the vicinity thereof is strong enough that it can withstand a rotational moment of force via the electrode terminal PT or the electrode terminal NT, for example, to a substantial degree, particularly even when a thin cover plate 2 is used in order to lighten the energy storage element 100.

The depression 23 is formed to displace what will be the main source material for the formation of the protrusion 2b on the cover plate 2 by press working (plastic working).

From the viewpoint of the extending direction of the protrusion 2b, the breadth of the depression 23 formation (on the surface of the cover plate 2) is greater than the breadth of the protrusion 2b formation from the same viewpoint, easily ensuring that enough material is secured for the formation of the protrusion 2b.

Moreover, in the extending direction of the protrusion 2b, the bottom surface of the depression 23 is positioned closer to the side of the surface of the cover plate 2 on which the depression 23 is formed (the inner surface of the cover plate 2 of the container 101) than the side of the surface of the cover plate 2 on which the protrusion 2b is formed (the outer surface of the cover plate 2 of the container 101).

Along with a recess on the bottom surface for fitting with the raised collector seat 2a and a recess on the top surface for fitting with the rivet head 8a of the rivet 8 and the rivet head 15a of the rivet 15 as previously described, the upper gasket 10 and the upper gasket 16 also include a through hole 31 formed in the positioning portion 10b and the positioning portion 16b for the protrusion 2b to pass through (see FIG. 3 and FIG. 4).

As previously described, the lower gasket 12 and the lower gasket 17 include a raised portion on the top surface for fitting with the recess formed on the raised collector seat 2a, and a recess on the bottom surface for holding the top of the current collector 4 and the current collector 6.

The tops of the current collector 4 and the current collector 6 include a step formed thereon that rises to fit with the recess formed in the bottom surface of the lower gasket 12 and the lower gasket 17.

In the process of assembling the components to be attached to the cover plate 2, the upper gasket 10 and the upper gasket 16 are fitted to the respective raised collector seats 2a and the protrusions 2b formed on the cover plate 2 (see FIG. 5), and the lower gasket 12, the lower gasket 17, the current collector 4, and the current collector 6 are fitted to the inside of the cover plate 2 of the container 101. Next, the rivet 8 and the rivet 15 are inserted in the respective through holes (the through hole 10a, for example) formed in each of the components from the top side (the outside of the container 101).

In this inserted state, the ends of the rivet 8 and the rivet 15 are swaged from the inside of the container 101 (see FIG. 3). If required, the ends of the protrusion 2b are also swaged (see FIG. 6). The swaging of the protrusion 2b may be performed by pressing the protrusion 2b with a sphere-point or ball-point tool to flare the wall of the tubular portion 22 outward.

The positioning portion 10b of the upper gasket 10 and the positioning portion 16b of the upper gasket 16 include an inclined surface 32 with which the tubular portion 22 engages in the through hole 31 after swaging and that inclines outward with respect to the through hole 31, that is, gradually inclines away from the surface of the cover plate 2 as the distance from the protrusion 2b increases. Moreover, the inclined surface 32 is positioned further from the surface of the cover plate 2 than the base portion 21 is positioned from the surface of the cover plate 2. With the provision of the inclined surface 32, the tubular portion 22 of the protrusion 2b can be kept from bending excessively.

By configuring the assembly parts assembled to the cover plate 2 as described above, rotation of the electrode terminal NT and the electrode terminal PT can be prevented with the upper gasket 10 and the upper gasket 16 since the protrusions 2b on the cover plate 2 are engaged with the positioning portion 10b of the upper gasket 10 and the positioning portion 16b of the upper gasket 16, even if a rotational external force is applied to the electrode terminal NT or the electrode terminal PT. There are examples of two energy storage elements 100 connected by their respective electrode terminals NT and electrode terminals PT with a bus bar, for example, relatively shifting in position as a result of the two energy storage elements 100 vibrating, for example, when a rotational external force is applied to the electrode terminal NT or the electrode terminal PT. Moreover, external rotational force is applied to the electrode terminal NT and the electrode terminal PT when the bolts fastening the electrode terminal NT and the electrode terminal PT are swaged or when the electrode terminal NT and the electrode terminal PT are themselves swaged.

Moreover, in this embodiment, rotation of the electrode terminal NT and the electrode terminal PT is prevented as a result of the upper gasket 10 and the upper gasket 16 engaging with the raised collector seats 2a.

### Embodiment Variations

Variations of the embodiment according to the present invention will be listed hereinafter.

(1) In the embodiment, the protrusion 2b is formed in a simple manner on the cover plate 2 by press working, whereby the tubular portion 22 is formed stacked on the base portion 21, and the depression 23 is formed on the surface opposite the surface on which the protrusion 2b is formed. However, a variety of variations to each component are possible in the formation of the protrusion 2b.

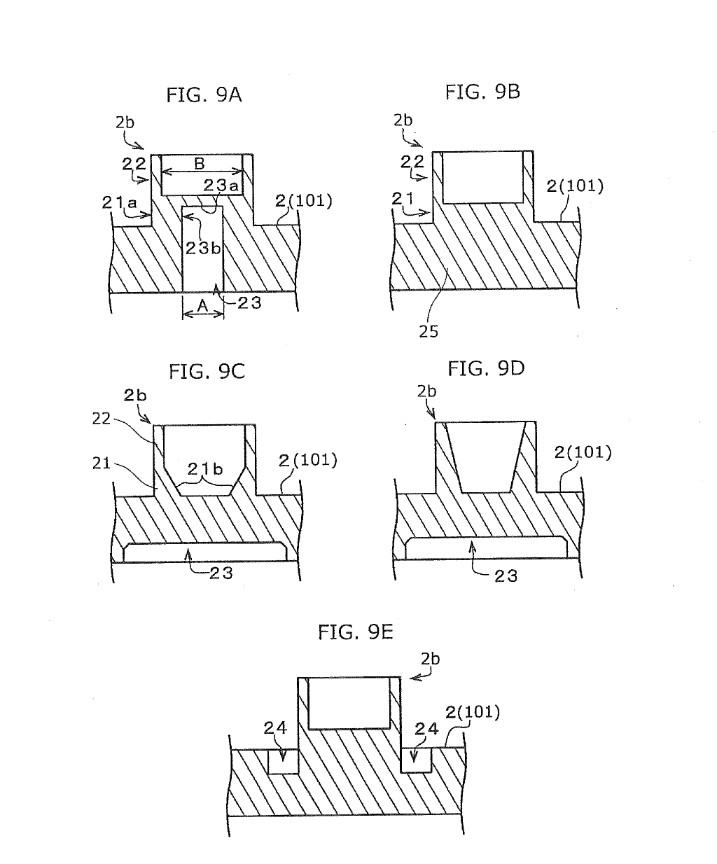

FIG. 9A and FIG. 9E show examples of these variations.

First, the configuration shown in FIG. 9A has a different shaped depression 23 than the protrusion 2b according to the embodiment.

The depression 23 shown in FIG. 9A is formed such that a distance between a bottom surface 23a of the depression 23 and the tip end of the protrusion 2b in the extending direction is shorter than a distance between the surface of the cover plate 2 on which the protrusion 2b is formed and tip end of the protrusion 2b in the extending direction. Moreover, from the viewpoint of the extending direction of the protrusion 2b (the normal direction of the cover plate 2), the breadth of the depression 23 formation is smaller. That is to say, from the viewpoint of the extending direction, the diameter A of the depression 23 is smaller than the diameter B of the tubular portion 22.

With this, in the region from the surface on which the protrusion 2b is formed on the cover plate 2 to a set position at the tip end of the protrusion 2b in the extending direction, the wall of the protrusion 2b formed of a side surface 23b of the depression 23 and a side surface 21a of the protrusion 2b is a thick wall that is thicker than the wall of the protrusion 2b at the tip end in the extending direction thereof (the wall of the tubular portion 22).

The protrusion 2b is sufficiently strong against external forces acting along the formation surface thereof as a result of the formation of this thick wall.

The configuration shown in FIG. 9B is different from than the protrusion 2b according to the embodiment in that the depression 23 is provided across the whole cover plate 2.

The wall 25 is be made to be the thickest with this variation.

It is to be noted that for forming the protrusion 2b according to this variation by press working, the number of times the workpiece is pressed in the pressing process can be increased, for example, to uniformly collect the material to form the protrusion 2b from across the entire cover plate 2.

Next, the configuration shown in FIG. 9C has a thick-walled tubular base portion 21 from the surface of the cover plate 2 on which the protrusion 2b is formed to the set position of the extending direction tip end, similar to FIG. 9A. In other words, the base portion 21 is not solid, but is a tube-shaped portion having thicker walls than the tubular portion 22. The wall of the base portion shown in FIG. 9C inclines in at least one wall surface (the inner wall inclined surface 21b in FIG. 9C). In other words, the wall of the base portion 21 from the base end of the protrusion 2b to the tip end gradually decreases in thickness.

Moreover, as FIG. 9D shows, at least one wall surface (the inner wall surface in FIG. 9D) of the whole protrusion 2b may be formed at an incline. In other words, the wall of the base portion 21 from the base end of the protrusion 2b to the tip end, and the wall of the tubular portion 22 are formed to continually and gradually decrease in thickness.

In this case, a portion from the bottom of the protrusion 2b to a given position along the length of the protrusion 2b in the extending direction can be recognized as the base portion 21.

Next, in contrast to the embodiment in which the depression 23 formed to provide material for the formation of the protrusion 2b is located on the surface of the cover plate 2 opposite the surface on which the protrusion 2b is formed, the configuration in FIG. 9E is provided with a ring shaped depression 24 surrounding the protrusion 2b on the same surface of the cover plate 2 that the protrusion 2b is formed. The material displaced in the forming of the depression 24 is used as the main source of material for the formation of the protrusion 2b.

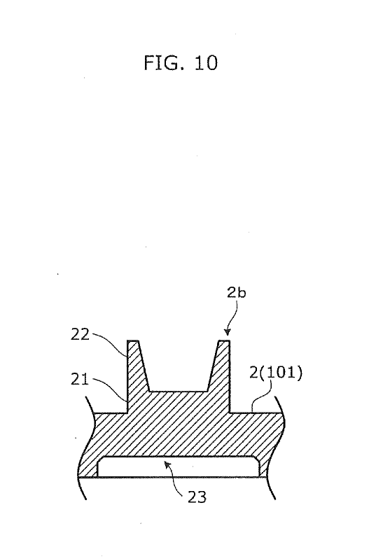

Moreover, as FIG. 10 shows, the protrusion 2b may include a solid base portion 21 and a tubular portion having a wall that gradually decreases in thickness from the base end of the protrusion 2b to the tip end.

In the above exemplary configurations and the above-described embodiment, the shape of the protrusion 2b, for example, is described as being a circular column or circular tube based shape, but the shape of the protrusion may be a rectangular column or rectangular tube based shape. The specific shapes of the protrusion 2b, the depression 23, or the depression 24 are changeable to suit the application. In other words, the shape of the tube is not limited to being cylindrical, but may be rectangular, or any other tube having a given cross-sectional shape.

It is to be noted that when the tubular portion is to be swaged, it is preferred that the tubular portion be cylindrical.

(2) The embodiment describes an example in which the tubular portion 22 is swaged after the protrusion 2b formed on the cover plate 2 is fitted into the through hole 31 formed in the positioning portion 10b and the positioning portion 16b of the upper gasket 10 and the upper gasket 16. However, a configuration is acceptable in which the protrusion 2b is fitted into the through hole, and rotation of the upper gasket 10 and the upper gasket 16, for example, is prevented without swaging the tubular portion 22.
(3) The embodiment describes an example in which a single protrusion 2b is provided for a single upper gasket 10, for example. However, a plurality of protrusions 2b may be provided for a single upper gasket 10 and may cooperate to prevent rotation of the upper gasket 10.
(4) The embodiment describes an example in which the cover plate 2 which is a metal plate member is made of aluminum. However, any type of metallic material which can be used in plastic working is applicable to the present invention. For example, stainless steel is acceptable.
(5) The embodiment exemplified an energy storage element 100, but a capacitor or other energy storage device is indented to be included in the energy storage element 100.
(6) The embodiment describes an example in which the component that engages with the protrusion 2b is the through hole 31. However, as a simple recess (an engaging recess) or notch, for example, may be formed to engage with the protrusion 2b.
(7) The embodiment describes an example in which the protrusion 2b is formed on the outer surface of the cover plate 2 of the container 101. However, the protrusion 2b may be provided on an inner surface of the cover plate 2 of the container 101, or on the case 1. With this kind of configuration can be used when fixing the protrusion 2b to the lower gasket 12 and the lower gasket 17, or when providing the electrode terminal NT and the electrode terminal PT on the case 1.
(8) The embodiment describes an example in which the protrusion 2b is formed on the container 101 of the energy storage element 100. However, the protrusion 2b may be formed on a different metal component included in the energy storage element 100. For example, by forming the protrusion 2b on the top ends of the current collector 4 and the current collector 6 and forming engaging recesses on the lower gasket 12 and the lower gasket 17, the protrusion 2b may be used to position and prevent rotation of the current collector 4 and the current collector 6.
(9) The embodiment describes an example in which the cover plate 2 on which the protrusion 2b is formed is used to describe the configuration of the assembly parts on the cover plate 2 side of the energy storage element 100 and the configuration of the container 101. However, a variety of plate member and assembly parts are applicable to the present invention.

1. An energy storage element comprising
a metal component that is a metal plate member including a protrusion extending from a surface of the metal plate member, and is provided as a portion of a container,
wherein the protrusion includes:
a tubular portion provided at a tip end of the protrusion in an extending direction that intersects with the surface; and
a base portion that is solid or tubular and extends from the surface of the metal component to the tubular portion in the extending direction, the base portion, when tubular, having a wall thickness greater than a wall thickness of the tubular portion.

2. The energy storage element according to claim 1,
wherein the base portion and the tubular portion are seamless and share a central axis.

3. The energy storage element according to claim 1,
wherein a wall of the protrusion is formed to gradually decrease in thickness in the extending direction from a base end toward the tip end.

4. The energy storage element according to claim 1, comprising
a depression that is closed-ended, formed on a surface of an opposite side of the metal component from a surface on which the protrusion is formed, and positioned to overlap a position of the protrusion when viewed from the extending direction.

5. The energy storage element according to claim 4,
wherein a distance between a bottom of the depression and the tip end of the protrusion in the extending direction is shorter than a distance between the surface of the metal component on which the protrusion is formed and the tip end of the protrusion in the extending direction.

6. The energy storage element according to claim 4,
wherein the depression is formed to be wider than the protrusion when viewed from the extending direction.

7. The energy storage element according to claim 4,
wherein the depression is less than half as deep as the metal component is thick.

8. The energy storage element according to claim 1,
wherein a wall of the tubular portion gradually decreases in thickness from a base end toward the tip end of the protrusion.

9. The energy storage element according to claim 1,
wherein the depression is provided on a same surface of the metal component as the protrusion.

10. The energy storage element according to claim 1,
wherein the protrusion engages with a gasket provided between an electrode terminal and the metal component.

11. The energy storage element according to claim 10,
wherein the tubular portion of the protrusion is fitted in a through hole formed in the gasket and swaged.

12. The energy storage element according to claim 11,
herein the gasket is provided with an inclined surface that gradually inclines away from the surface of the metal component from the inside of the through hole engaging with the swaged tubular portion out.

13. The energy storage element according to claim 12,
wherein a distance between the inclined surface and the surface of the metal component is greater than a distance between the base portion and the surface of the metal component.

14. A metal component that is a metal plate member, the metal component comprising:
a protrusion extending from a surface of the metal plate member,
wherein the protrusion includes:
a tubular portion provided at a tip end of the protrusion in an extending direction that intersects with the surface; and
a base portion that is solid or tubular and extends from the surface of the metal component to the tubular portion in the extending direction, the base portion, when tubular, having a wall thickness greater than a wall thickness of the tubular portion.

15. A method of manufacturing an energy storage element including, as a portion of a container, a metal component that is a metal plate member including a protrusion extending from a surface of the metal plate member, the method comprising
pressing the metal plate member to form the protrusion including (i) a tubular portion provided at a tip end of the protrusion in an extending direction that intersects with the surface and (ii) a base portion that is solid or tubular and extends from the surface of the metal component to the tubular portion in the extending direction, the base portion, when tubular, having a wall thickness greater than a wall thickness of the tubular portion.

16. The method of manufacturing an energy storage element according to claim 15, further comprising
swaging the tubular portion of the protrusion while the protrusion is fitted in a through hole formed in a gasket placed between an electrode terminal and the metal component.
